(19) United States
(12) Patent Application Publication
(10) Pub. No.: US 2025/0224543 A1
(43) Pub. Date: Jul. 10, 2025

(54) RESIN COMPOSITION, OPTICAL ELEMENT, OPTICAL APPARATUS, IMAGE PICKUP APPARATUS, AND METHOD FOR MANUFACTURING OPTICAL ELEMENT

(71) Applicant: CANON KABUSHIKI KAISHA, Tokyo (JP)

(72) Inventor: HIDEO UKUDA, Kanagawa (JP)

(21) Appl. No.: 19/012,329

(22) Filed: Jan. 7, 2025

(30) Foreign Application Priority Data
Jan. 9, 2024 (JP) 2024-001529

(51) Int. Cl. G02B 1/04; B29D 11/00; C08F 2/48; C08F 220/18; C08F 222/10; G02B 3/00; G02B 3/04

(52) U.S. Cl. CPC G02B 1/041; B29D 11/00019; B29D 11/00403; B29D 11/00442; C08F 2/48; C08F 220/1811; C08F 222/102; G02B 3/04; C08F 2800/20; G02B 2003/0093

(57) ABSTRACT

A resin composition contains a first monomer containing a polymerizable functional group of a difunctional (meth)acrylate having a fluorene skeleton, and at least one of a second monomer containing a polymerizable functional group of a monofunctional (meth)acrylate having an alicyclic skeleton, a polymer of the second monomer, and a third monomer containing a polymerizable functional group of a difunctional (meth)acrylate having an alicyclic skeleton. The total amount of the first monomer, the second monomer, the polymer of the second monomer, and the third monomer contained is 70% or more by mass and 99.5% or less by mass.

### BACKGROUND

### Technical Field

The present disclosure relates to a resin composition, an optical element, an optical apparatus, an image pickup apparatus, and a method for manufacturing an optical element.

### Description of the Related Art

One of the optical elements known is a lens including a cured resin composition disposed on a transparent base material of, for example, glass. Such a lens is manufactured by placing a resin composition between a base and a mold and polymerizing or copolymerizing the resin composition to form a cured product having a predetermined shape on a surface of the base. Lenses manufactured by such a manufacturing method are called replica elements. Replica elements are effective for use as aspherical lenses and Fresnel lenses because desired surface shapes can be easily formed. The term “aspherical lens” is a general term for a lens whose curvature changes continuously from the lens center to the periphery. Japanese Patent Laid-Open Nos. 6-298886 and 2023-55538 disclose resin compositions that can be used for replica elements.

### SUMMARY

One aspect of the present disclosure is directed to providing a resin composition that contains a first monomer containing a polymerizable functional group of a difunctional (meth)acrylate having a fluorene skeleton represented by formula (1) and at least one of a second monomer containing a polymerizable functional group of a monofunctional (meth)acrylate having an alicyclic skeleton represented by any of formulae (2) to (5), a polymer of the second monomer, and a third monomer containing a polymerizable functional group of a difunctional (meth)acrylate having an alicyclic skeleton represented by any of formulae (2) to (5), in which the total amount of the first monomer, the second monomer, the polymer of the second monomer, and the third monomer contained is 70% or more by mass and 99.5% or less by mass,

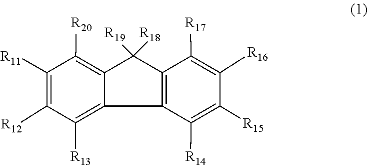

where in formula (1), at least two of R₁₁ to R₂₀ each contain a polymerizable functional group of a (meth)acrylate, and remaining groups are each a hydrogen atom or an organic group,

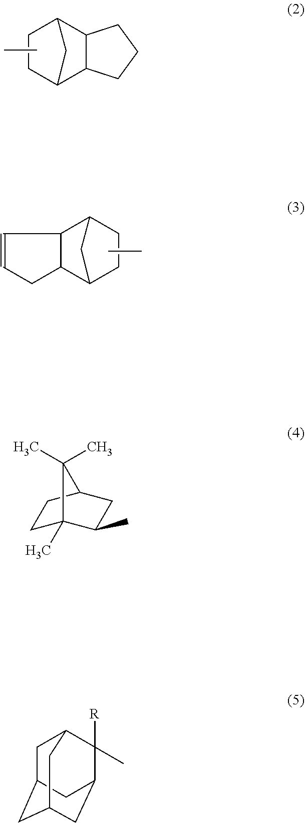

where in formula (5), R is a hydrogen atom, an alkyl group, or a substituted or unsubstituted alkylene group.

Further features of the present disclosure will become apparent from the following description of exemplary embodiments with reference to the attached drawings.

### BRIEF DESCRIPTION OF THE DRAWINGS

FIG. 1 is a schematic view of an optical element according to an embodiment of the present disclosure.

FIGS. 2A and 2B are schematic views of a method for manufacturing an optical element according to an embodiment of the present disclosure.

FIG. 3 is a schematic view of an image pickup apparatus according to an embodiment of the present disclosure.

FIG. 4 is a schematic view illustrating the thickness of a cured product in an optical element in an example.

### DESCRIPTION OF THE EMBODIMENTS

Embodiments of the present disclosure will be described below.

### Optical Element

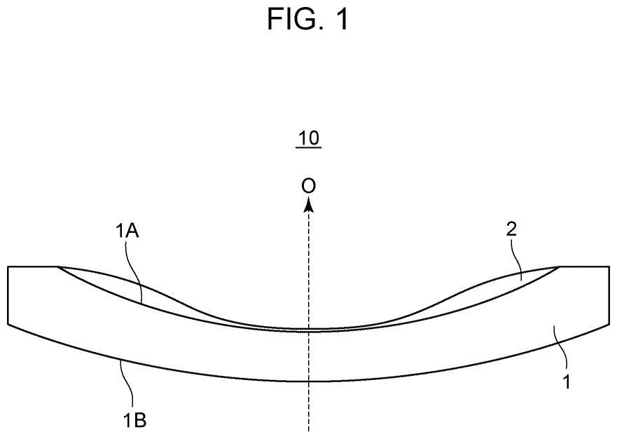

FIG. 1 is a schematic view illustrating an optical element according to a first embodiment, and is a side sectional view of an optical element 10 taken along a straight line passing through the element center O of the optical element in the lamination direction.

The optical element 10 has a transparent base material 1 and a cured product 2. The optical element 10 is a type of optical element called a replica lens in which a cured product is disposed on the transparent base material 1.

### Transparent Base Material

The transparent base material 1 has a first surface 1A and a second surface 1B, which are optical surfaces. The first surface 1A of the transparent base material is one of a light entrance surface and a light exit surface, and the second surface 1B of the transparent base material is the other of the light entrance surface and the light exit surface.

The transparent base material 1 can be composed of a transparent resin or transparent glass. In this specification, the term “transparent” indicates that light transmittance at a wavelength of 400 nm or more and 780 nm or less is 10% or more. The transparent base material 1 can be composed of glass. Examples of the glass that can be used include common optical glasses, such as silicate glasses, borosilicate glasses, and phosphate glasses, quartz glass, and glass ceramics.

In FIG. 1, the first surface 1A has a concave spherical shape, and the second surface 1B has a convex spherical shape, but the transparent base material 1 is not limited to a particular shape. The shape of the surface of the transparent base material 1 in contact with the cured product 2 can be selected from, for example, a concave spherical shape, a convex spherical shape, an axisymmetric aspherical shape, and a planar shape in accordance with the desired properties. The transparent base material 1 can have a circular shape when viewed from above the paper surface of FIG. 1. This is because when the optical element 10 is used as a lens in an optical system described below, the assembly accuracy is improved.

### Cured Product

The cured product 2 adheres to the first surface 1A of the transparent base material. The cured product 2 is a cured product of a resin composition obtained by polymerizing or copolymerizing a resin composition 2a.

The resin composition 2a can contain a first material, a second material, and a polymerization initiator.

The first material is a first monomer containing a polymerizable functional group of a difunctional (meth)acrylate having a fluorene skeleton represented by formula (1).

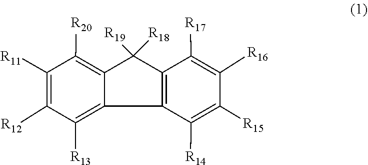

In formula (1), at least two of R₁₁ to R₂₀ each contain a polymerizable functional group of a (meth)acrylate, and remaining groups are each a hydrogen atom or an organic group. As the organic group, other polymerizable functional groups may be contained. Examples of the other polymerizable functional groups include a vinyl group and an epoxy group. In other words, R₁₁ to R₂₀ may each have, for example, a vinyl group-containing organic group or an epoxy group-containing organic group.

The component of the polymer of the first monomer plays a role in increasing the refractive index and decreasing the water absorption expansion rate in the cured product 2. However, the birefringence usually tends to be larger.

The first monomer can have a fluorene skeleton represented by formula (6). The fluorene skeleton represented by formula (6) plays a role in exhibiting a particularly high refractive index nd.

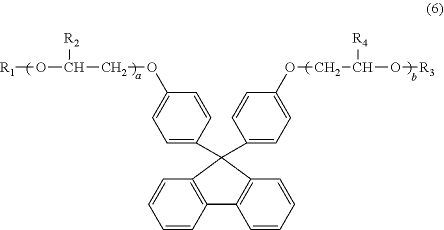

In formula (6), R₁ and R₃ are each selected from

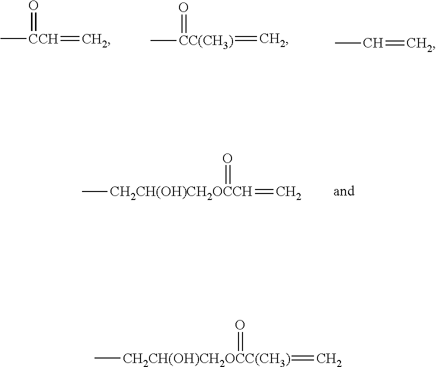

and R₂ and R₄ are each a hydrogen atom, CH₂, or an alkyl group.

The second material contains at least one of a second monomer containing a polymerizable functional group of a monofunctional (meth)acrylate having an alicyclic skeleton represented by any of formulae (2) to (5), a polymer of the second monomer, and a third monomer containing a polymerizable functional group of a difunctional (meth)acrylate having an alicyclic skeleton represented by any of formulae (2) to (5).

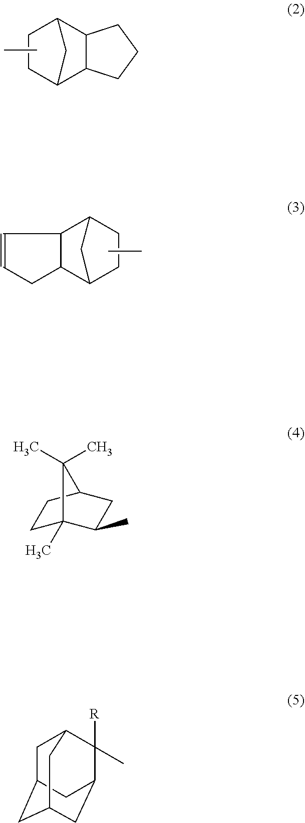

In formula (5), R is a hydrogen atom, an alkyl group, or a substituted or unsubstituted alkylene group.

The alicyclic skeleton represented by formula (2) is a tricyclodecane skeleton. The alicyclic skeleton represented by formula (3) is an isobornyl skeleton. The alicyclic skeleton represented by formula (4) is a dicyclopentenyl skeleton. The alicyclic skeleton represented by formula (5) is an adamantane skeleton. Polymers each prepared by polymerizing a monomer having the tricyclodecane skeleton, the isobornyl skeleton, the dicyclopentenyl skeleton, or the adamantane skeleton function to reduce the water absorption expansion rate of the cured product 2. In addition, the alicyclic structures having the respective steric configurations function to inhibit a reduction in birefringence caused by the first material.

The resin composition 2a according to an embodiment of the present disclosure may further contain a third monomer containing a polymerizable functional group of a difunctional (meth)acrylate having an alicyclic skeleton represented by any of the above formulae (2) to (5).

In the resin composition 2a according to an embodiment of the present disclosure, the total amount of the first material and the second material contained is 70% or more by mass and 99.5% or less by mass. When the resin composition 2a according to an embodiment of the present disclosure has the above-mentioned composition ratio, a cured product obtained by curing the resin composition 2a has a low water absorption expansion rate and excellent adhesion to the transparent base material. When the total amount contained is more than 99.5% by mass, the polymerization initiator content is relatively low. This makes curing difficult and leads to inadequate transfer accuracy of the cured product 2, resulting in variations in optical performance. When the total amount contained is less than 70% by mass, the cured product 2 has a high water absorption expansion rate; thus, the optical performance is prone to change in a high-humidity environment, such as a humidity of 80% or more.

The resin composition 2a according to an embodiment of the present disclosure can have a first monomer content of 10% or more by mass and 30% or less by mass. Within this range, it is easy to reduce the birefringence and to increase the refractive index nd at the d-line to 1.54 or more. At less than 10% by mass, it can be difficult to increase the refractive index nd of the cured product 2 at the d-line, depending on the composition ratio. At more than 30% by mass, the birefringence of the cured product 2 can be increased, depending on the composition ratio.

In the resin composition 2a according to an embodiment of the present disclosure, the total amount of the second monomer, the polymer of the second monomer, and the third monomer can be 40% or more by mass and 85.9% or less by mass. Within this range, it is easy to reduce the birefringence and to increase the refractive index nd at the d-line to 1.54 or more. At less than 40% by mass, the birefringence of the cured product 2 can be increased, depending on the composition ratio. At more than 85.9% by mass, it can be difficult to increase the refractive index nd of the cured product 2 at the d-line.

The resin composition 2a contains the polymerization initiator. The polymerization initiator may be a photoinitiator or a thermal polymerization initiator, which can be determined in accordance with a manufacturing process selected. In the case of replica molding for producing an aspherical shape, a photoinitiator can be used from the viewpoint of its high curing rate. Examples of a commercially available photoinitiator include 2-benzyl-2-(dimethylamino)-1-[4-(morpholino)phenyl]-1-butanone, 1-hydroxycyclohexyl phenyl ketone, bis(2,4,6-trimethylbenzoyl)phenylphosphine oxide, 4-phenylbenzophenone, 4-phenoxybenzophenone, 4,4′-diphenylbenzophenone, and 4,4′-diphenoxybenzophenone. The resin composition 2a can have a photoinitiator content of 0.01% or more by mass and 10% or less by mass. A photoinitiator content of less than 0.01% by mass may result in insufficient reactivity. A photoinitiator content of more than 10% by mass may result in a decrease in the transmittance of the cured product 2. An unreacted polymerization initiator remains in the cured product 2.

If necessary, a polymerization inhibitor, an antioxidant, a light stabilizer (hindered amine light stabilizer, HALS), an ultraviolet absorber, a silane coupling agent, a release agent, a pigment, a dye, and other additives may be added to the resin composition 2a.

The cured product 2 can have low birefringence, specifically within ±0.0004. The birefringence of the cured product 2 is the difference between a refractive index n_{d}^{s} for S-polarized light (in-plane direction of the plane of incidence) and a refractive index n_{d}^{p} for P-polarized light (thickness direction) of the d-line (587.6 nm). The plane of incidence is a surface opposite to the first surface 1A of the transparent base material. The refractive index nd of the cured product 2 at the d-line (587.6 nm) can be 1.54 or more and 1.58 or less. When the refractive index is increased, the aspherical effect of the cured product, which is correlated with the product of the refractive index and the thickness, can be enhanced. With regard to the cured product disclosed in Japanese Patent Laid-Open No. 2023-55538, when the cured product having a refractive index nd of 1.54 or more was formed on a transparent base material, the cured product sometimes had high birefringence. In contrast, according to an embodiment of the present disclosure, it is able to provide the cured product 2 that has low birefringence and that is less prone to change in optical performance even in a high-humidity environment.

The cured product 2 can have high transparency. Specifically, the internal transmittance at a wavelength of 400 nm and a converted thickness of 500 μm can be 70% or more.

The cured product 2 can have an Abbe number of 30 or more and less than 45. Within these ranges, various optical designs can be used when the optical element 10 is used as a lens in an optical system.

In FIG. 1, the cured product 2 has a non-uniform thickness within the plane of the first surface 1A. That is, the shape of the surface of the cured product 2 that is not in contact with the transparent base material 1 is aspherical. In the present embodiment, the cured product has a thickness distribution with the minimum thickness d1 at about the center O of the element and the maximum thickness d2 at the peripheral portion of the element. However, this shape is not necessarily required. For example, the thickness distribution may have the maximum thickness d2 at about the center O of the element and the minimum thickness d1 at the peripheral portion of the element. The ratio of the maximum thickness d2 to the minimum thickness d1 of the cured product 2 is preferably more than 1 and 30 or less. At a ratio of more than 30, the large difference in the thickness of the cured product 2 may result in a failure to maintain a high surface accuracy during cure shrinkage. More preferably, the ratio is 8 or more. The minimum thickness d1 can be 300 μm or less, and the maximum thickness d2 can be 10 μm or more and 1,000 μm or less.

The water absorption expansion rate of the cured product 2 disposed on the transparent base material 1 is preferably less than 0.30%. This is because the change in optical properties caused by expansion due to water absorption can be reduced. A water absorption expansion rate of 0.30% or more results in a significant change in the surface shape of the cured product 2 before and after water absorption. This may cause a change in image quality when the cured product 2 is used in an optical system. The water absorption expansion rate is more preferably 0.20% or less.

The water absorption expansion rate is still more preferably 0.15% or less. The water absorption expansion rate can be evaluated by placing the optical element 10 in a constant temperature and humidity chamber at a temperature of 40° C. and a humidity of 90% for 16 hours, taking out the optical element 10 in a room-temperature environment (23° C.±2° C.), and after 20 minutes, evaluating the surface shape of the cured product 2 with a surface profiler.

In the present embodiment, the optical element 10 includes the transparent base material 1. However, the transparent base material 1 need not be included, depending on the optical properties of the optical element 10.

### Method for Manufacturing Optical Element

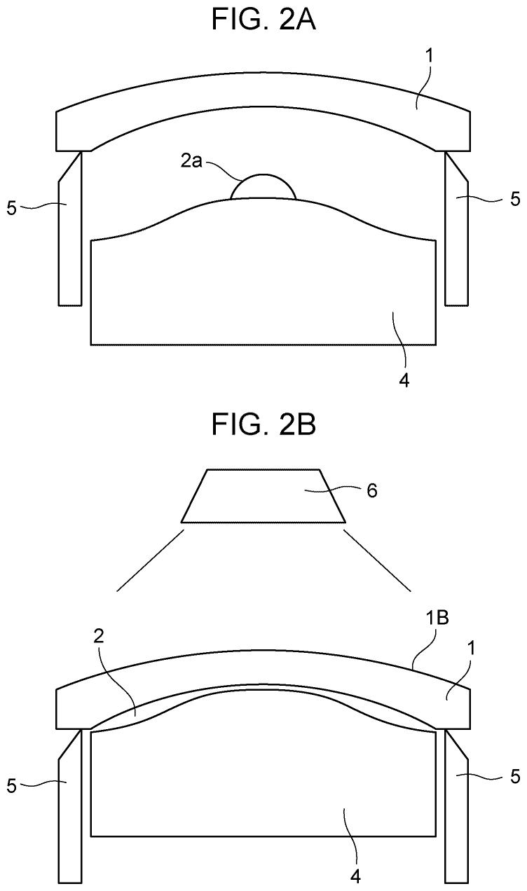

A method for manufacturing an optical element according to the above-described embodiment is not particularly limited. An example of the manufacturing method will be described below. FIGS. 2A and 2B are schematic views illustrating a method for manufacturing an optical element according to the above-described embodiment.

The transparent base material 1 and the resin composition 2a are provided (preparation step). To improve the adhesion between the transparent base material 1 and the cured product 2, the first surface 1A of the transparent base material can be subjected to pretreatment. When the transparent base material 1 is composed of glass, for example, silane coupling treatment, corona discharge treatment, UV-ozone treatment, and plasma treatment can be selected. From the view point of forming direct chemical bonds of the cured product 2 with the first surface 1A to further improve the adhesion, coupling treatment with a silane coupling agent can be performed. Specific examples of the coupling agent include hexamethyldisilazane, methyltrimethoxysilane, trimethylchlorosilane, and triethylchlorosilane.

A method for preparing the resin composition 2a is not particularly limited. There are no particular restrictions on the mixer or mixing time, and mixing can be performed so as to prepare a uniform composition.

As illustrated in FIG. 2A, the resin composition 2a is dropped onto a mold 4. The resin composition 2a is an ultraviolet curable composition containing a photoinitiator. The transparent base material 1 is placed on an ejector 5 and disposed at a position facing the mold 4. The mold 4 is, for example, a mold that has an inverted shape of a desired aspherical shape on a surface and can be manufactured by cutting a metal base of, for example, a stainless steel material or a steel material, plated with NiP or oxygen-free copper by a precision processing machine. The surface of the mold 4 may be coated with a release agent to control the releasability of the resin. The type of mold release agent is not particularly limited. An example thereof is a fluorine-containing coating agent.

Subsequently, as illustrated in FIG. 2B, the ejector 5 is lowered to bring the mold 4 closer to the transparent base material 1, thereby providing the resin composition 2a on the transparent base material 1 (disposition step). The ejector 5 is further lowered to fill the gap between the mold 4 and the transparent base material 1 with the uncured resin composition 2a to form a desired shape (molding step).

Ultraviolet irradiation is performed from the second surface 1B side of the transparent base material 1 using an ultraviolet light source 6 to provide the cured product 2 that is a polymerized and cured product of the resin composition 2a (curing step, light irradiation step).

Thereafter, the cured product 2 obtained by polymerization and curing is released from the mold 4 to provide the optical element 10 including the cured product 2 having an aspherical shape on the transparent base material 1. After the cured product 2 is formed, additional ultraviolet irradiation or heat treatment may be performed in air or in an oxygen-free atmosphere.

The optical element according to the first embodiment can be manufactured by the above manufacturing method. In the disposition step, the resin composition 2a may be dropped onto both the mold 4 and the transparent base material 1, or may be dropped onto the transparent base material 1 only. When the resin composition 2a contains a thermal polymerization initiator as a curing initiator, the light irradiation step may be changed to a heat treatment step. After the curing step, the transparent base material 1 may be separated from the optical element 10 and only the cured product 2 may be used as the optical element 10.

### Optical Apparatus

Specific application examples of the optical element of the above-described embodiment include lenses included in optical apparatus (photographic optical systems) for cameras and camcorders, and lenses included in optical apparatus (projection optical systems) for liquid crystal projectors. Moreover, the optical element can be used for a pickup lens of a DVD recorder or the like. These optical systems each include at least one lens disposed in a housing, and the above-described optical element can be used for the at least one lens.

### Image Pickup Apparatus

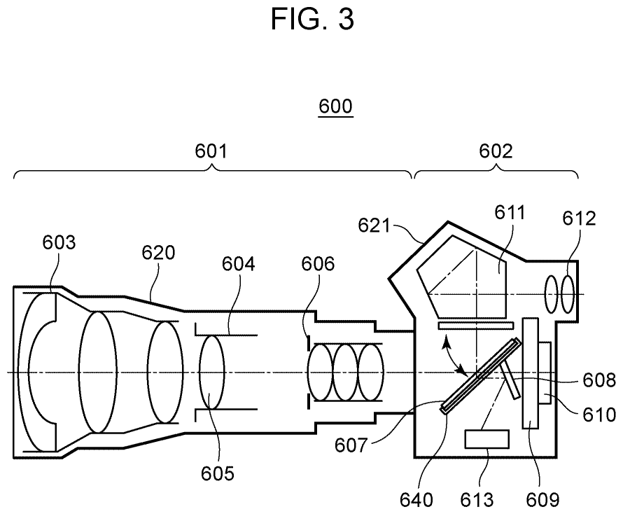

FIG. 3 is a schematic view illustrating the configuration of a digital single-lens reflex camera 600 as an example of an embodiment of an image pickup apparatus including the optical element according to the above-described embodiment. In FIG. 3, a camera main body 602 and a lens barrel 601, which is an optical apparatus, are connected to each other. The lens barrel 601 is what is called an interchangeable lens that can be attached to and detached from the camera main body 602.

Light from a subject is captured through an optical system including, for example, a plurality of lenses 603 and 605 arranged on the optical axis of the photographic optical system in a housing 620 of the lens barrel 601. The optical element according to the first embodiment can be used for each of the lenses 603 and 605, for example. Here, the lens 605 is supported by the inner cylinder 604, and is movably supported with respect to the outer cylinder of the lens barrel 601 for focusing and zooming.

For the duration of observation before capturing, light from a subject is reflected by a main mirror 607 in the housing 621 of the camera main body and passes through a prism 611. Then, a photographer sees the capturing image through a viewfinder lens 612. The main mirror 607 is, for example, a semi-transparent mirror. The light that has passed through the main mirror is reflected by a sub-mirror 608 toward an autofocusing (AF) unit 613. This reflected light is used for, for example, focusing. The main mirror 607 is mounted on and supported by a main mirror holder 640 using adhesion or the like. During capturing, the main mirror 607 and the sub-mirror 608 are moved to positions outside the optical path using a driving mechanism (not illustrated), a shutter 609 is opened, an image pickup element 610 receives light that has been incident from the lens barrel 601 and passed through the photographic optical system, and a photographic light image is focused thereon. A diaphragm 606 is configured in such a manner that the brightness and the focal depth during capturing can be changed by adjusting the aperture area.

Although the image pickup apparatus has been described here using the digital single-lens reflex camera, the image pickup apparatus can also be used in the same way for smartphones, compact digital cameras, drones, and so forth.

### EXAMPLES

Examples and comparative examples will be described below. First, evaluation methods in examples and comparative examples will be described.

### Water Absorption Test

The water absorption expansion rates of cured products of optical elements in examples and comparative examples were each evaluated with an optical element including a cured product disposed on a transparent base material.

The resulting optical element was placed in a constant temperature and humidity chamber at a temperature of 40° C. and a humidity of 90% for 16 hours.

Subsequently, the optical element was taken out in a room-temperature environment (23° C.±2° C.), and after 20 minutes, the surface shape of the cured product was evaluated with a surface profiler (Form Talysurf Laser, available from TAYLOR HOBSON). The measurement was performed by linearly scanning light from an end portion of the optical element to the opposite end portion through the center portion at a scanning rate of 0.5 mm/s. The water absorption expansion rate [%] of the optical element was calculated from the following formula using the average thickness DO before water absorption and the average thickness D1 after water absorption.

$$Water absorption expansion rate [ \% ] = ( ( D 1 - D 0 ) / D 0 ) \times 100$$

The evaluation was performed as described below.
A: There was no peeling of the cured product, and the water absorption expansion rate was less than 0.20%.
B: There was no peeling of the cured product, and the water absorption expansion rate was less than 0.30%.
C: The cured product was peeled off or the water absorption expansion rate was 0.30% or more.

### D-Line Refractive Index nd, Abbe Number νd, and Birefringence

The refractive index nd, the Abbe number νd, and the birefringence of the cured products of the optical elements of examples and comparative examples were evaluated by preparing samples for the evaluation of the optical properties. It is also possible to peel off the transparent base material from the optical element and take out the cured product for evaluation without using a sample for the evaluation of the optical properties. First, a method for preparing a sample for the evaluation of the optical properties will be described.

A spacer having a thickness of 500 μm and an uncured resin composition, as a precursor for a cured product to be measured, were placed on a glass sheet (S-TIH, available from Ohara Inc.) having a thickness of 1 mm. A quartz glass sheet having a thickness of 1 mm was placed thereon with the spacer interposed therebetween to spread the uncured resin composition. The spacer was removed. A sheet of glass (S-TIM8), which is used in an element, was placed on top of the quartz glass sheet. Then, light irradiation was performed from above using a high-pressure mercury lamp (UL750, available from Hoya Candeo Optronics Corp.) at 20 mW/cm² (=illuminance at 405 nm through the quartz glass sheet and S-TIM8) for 2,500 seconds (50 J/cm²). The resin composition was cured. The quartz glass sheet was peeled off. The cured resin composition was annealed at 80° C. for 16 hours to provide a sample for the evaluation of the optical properties. The cured product had a thickness of 500 μm and a size of 5 mm×20 mm on the glass surface.

The refractive indices nf, nd, and nc of the resulting samples for P-polarized light (thickness direction) and S-polarized light (in-plane direction of the plane of incidence) at the f-line (486.1 nm), the d-line (587.6 nm), and the c-line (656.3 nm) were measured from the glass. The measurement was performed with a refractometer (KPR-30, available from Shimadzu Corporation). The measurement was performed multiple times, and the average value was taken as the refractive index of each wavelength.

The birefringence was defined as the difference between the refractive index n_{d}^{s} for S-polarized light (in-plane direction) and the refractive index nap for P-polarized light (thickness direction) of the d-line (587.6 nm).

$$Δ nd = {n}_{d}^{S} - {n}_{d}^{p}$$

The Abbe number was calculated from the measured refractive indices. The Abbe number νd was calculated from the following formula.

$$Abbe number vd = ( nd - 1 ) / ( nf - nc )$$

### Evaluation of Internal Transmittance

The internal transmittance of the cured product of the optical element of each of examples and comparative examples was evaluated by preparing a sample for the evaluation of optical properties. It is also possible to peel off the transparent base material from the optical element and take out the cured product for evaluation without using a sample for the evaluation of the optical properties. First, a method for preparing a sample for the evaluation of the optical properties will be described.

A spacer having a thickness of 500 μm and an uncured resin composition, as a precursor for a cured product to be measured, were placed on a glass sheet (BSL7, available from Ohara Inc.) having a thickness of 1 mm. A quartz glass sheet having a thickness of 1 mm was placed thereon with the spacer interposed therebetween to spread the uncured resin composition. The spacer was removed. A sheet of glass (S-TIM8), which is used in an element, was placed on top of the quartz glass sheet. Then, light irradiation was performed from above using a high-pressure mercury lamp (UL750, available from Hoya Candeo Optronics Corp.) at 20 mW/cm² (=illuminance at 405 nm through the quartz glass sheet and S-TIM8) for 2,500 seconds (50 J/cm²). The resin composition was cured. The quartz glass sheet was peeled off. The cured resin composition was annealed at 80° C. for 32 hours to prepare a sample for the evaluation of the optical properties. The cured product had a thickness of 500 μm and a size of 5 mm×20 mm on the glass surface.

The transmittance of the resulting sample in the visible region (2:400 to 700 nm) was measured using a spectrophotometer (UH4150, available from Hitachi High-Tech Science Corporation). The internal transmittance was calculated from the refractive indices of the glass substrate and the resin.

### Minimum Thickness d1 and Maximum Thickness d2

The minimum thickness d1 and the maximum thickness d2 of the cured product of the optical element of each of examples and comparative examples were evaluated using an optical element in which a cured product was disposed on a transparent base material.

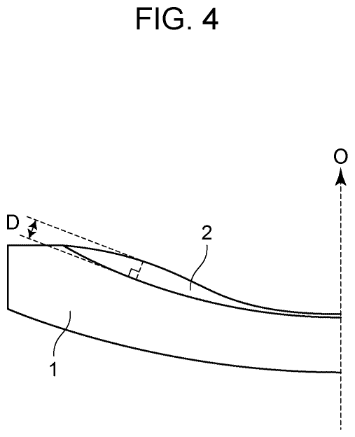

The resulting optical element was placed in a constant-temperature chamber at 80° C. for 16 hours. Subsequently, the optical element was taken out in a room-temperature environment (23° C.±2° C.), and after 20 minutes, the surface shape of the cured product was evaluated with a surface profiler (Form Talysurf Laser, available from TAYLOR HOBSON). The measurement was performed by linearly scanning light from an end portion of the optical element to the opposite end portion through the center portion at a scanning rate of 0.5 mm/s. The distance from the interface between the transparent base material 1 and the cured product 2 to the measured surface shape of the cured product 2 in the direction perpendicular to the interface was calculated to determine the thickness D of the cured product 2. FIG. 4 illustrates the thickness D. The average value of the thicknesses obtained in the radial direction was denoted as DO, the minimum thickness was denoted as d1, and the maximum thickness was denoted as d2.

### Manufacture of Optical Element

### Example 1

A resin composition 2a was first prepared. As a first monomer containing a polymerizable functional group of a difunctional (meth)acrylate having a fluorene skeleton, 9,9-bis [4-(2-hydroxyethoxy)phenyl]fluorene diacrylate (A-1: difunctional, A-BPEF, available from Shin-Nakamura Chemical Co., Ltd.) was provided.

Dicyclopentenyloxyethyl methacrylate (B-1: monofunctional, FA-512M, available from Resonac Corp.) was provided as a second monomer containing a polymerizable functional group of a monofunctional (meth)acrylate having an alicyclic skeleton. As a third monomer containing a polymerizable functional group of a difunctional (meth)acrylate having an alicyclic skeleton, tricyclodecanedimethanol diacrylate (C-1: difunctional, A-DCP, available from Shin Nakamura Chemical Co., Ltd.) was provided. Diphenyl(2,4,6-trimethylbenzoyl) phosphine oxide (D-1: photoinitiator, Omnirad TPO H, available from IGM Resins) was provided as a polymerization initiator. Then, 29.4 parts by mass of the first monomer A-1, 29.4 parts by mass of the second monomer B-1, 39.2 parts by mass of the third monomer B-4, and 2 parts by mass of the polymerization initiator D-1 were placed in a vessel and mixed uniformly to prepare a resin composition 2a of Example 1. Table 1 summarizes the characteristics of the resin composition 2a of Example 1.

An optical element illustrated in FIG. 1 was manufactured by the manufacturing method illustrated in FIGS. 2A and 2B. As the transparent base material 1, an optical glass base (S-TIM8, available from Ohara Inc.) with a diameter of 32 mm was provided. Regarding the shape, one surface (the first surface 1A) was a concave spherical shape with a radius of curvature of 40 mm, and the other surface (the second surface 1B) was a convex spherical shape with a radius of curvature of 75 mm. As the mold 4, a mold obtained by cutting a NiP layer plated on a metal base with a precision processing machine to form an inverted shape of the aspherical shape of the cured product 2 to be molded was used.

The resin composition 2a of Example 1 was filled into the gap between the transparent base material 1 and the mold 4. To cure the resin composition 2a, the entire surface was irradiated with ultraviolet rays having a wavelength of 405 nm and an intensity of 20 mW/cm² for 2,500 seconds. After the mold 4 was released, heating was performed at 80° C. for 24 hours to form the cured product 2 on the first surface 1A of the transparent base material 1, thereby providing the optical element 10 of Example 1.

The cured product 2 of the optical element of Example 1 had a water absorption expansion rate of 0.12%, and no peeling was observed. Thus, the cured product was rated A. The cured product 2 of Example 1 had a refractive index nd of 1.575 at the d-line and an Abbe number νd of 35.6. The birefringence was −0.00034, which was sufficiently low. The internal transmittance was 93.0%, which was good.

The cured product 2 of the optical element of Example 1 had a shape with the minimum thickness at the center portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 1.

TABLE 1

| | | | | | | | | | | | | | | Total of |
|---|---|---|---|---|---|---|---|---|---|---|---|---|---|---|
| | | | | | | | | | | | | | | first |
| | | | | | | | | | | | | | Total of | monomer, |
| | | | | | | | | | | | | | second | second |
| | First material | | Second material | | | | | | Other materials | | | | monomer, | monomer, |
| | First | | Second | | | | Third | | Another | | | | polymer, | polymer, |
| | monomer | | monomer | | Polymer | | monomer | | monomer | | Initiator | | and third | and third |
| | | Content | | Content | | Content | | Content | | Content | | Content | monomer | monomer |
| | | % by | | % by | | % by | | % by | | % by | | % by | % by | % by |
| Unit | Type | mass | Type | mass | Type | mass | Type | mass | Type | mass | Type | mass | mass | mass |
| Example 1 | A-1 | 29.4% | B-1 | 29.4% | | | C-1 | 39.2% | | | D-1 | 2.0% | 68.6% | 98.0% |
| Example 2 | A-1 | 19.6% | B-1 | 39.2% | | | C-1 | 39.2% | | | D-1 | 2.0% | 78.4% | 98.0% |
| Example 3 | A-1 | 10.8% | B-1 | 48.0% | | | C-1 | 39.2% | | | D-1 | 2.0% | 87.3% | 98.0% |
| Example 4 | A-1 | 23.5% | B-1 | 29.4% | B-2 | 15.7% | C-1 | 29.4% | | | D-1 | 2.0% | 74.5% | 98.0% |
| Example 5 | A-1 | 19.6% | B-1 | 44.1% | | | C-1 | 29.4% | E-1 | 4.9% | D-1 | 2.0% | 73.5% | 93.1% |
| Example 6 | A-1 | 10.8% | B-1 | 48.0% | | | C-1 | 29.4% | E-1 | 9.8% | D-1 | 2.0% | 77.5% | 88.2% |
| Example 7 | A-1 | 29.4% | B-3 | 29.4% | | | C-1 | 39.2% | | | D-1 | 2.0% | 68.6% | 98.0% |
| Example 8 | A-1 | 29.4% | B-3 | 29.4% | B-4 | 9.8% | C-1 | 29.4% | | | D-1 | 2.0% | 68.6% | 98.0% |
| Example 9 | A-1 | 29.4% | B-5 | 29.4% | | | C-1 | 39.2% | | | D-1 | 2.0% | 68.6% | 98.0% |
| Example 10 | A-1 | 29.4% | B-6 | 29.4% | | | C-1 | 39.2% | | | D-1 | 2.0% | 68.6% | 98.0% |
| Comparative | A-1 | 19.6% | B-1 | 9.8% | | | C-1 | 29.4% | E-1 | 39.2% | D-1 | 2.0% | 39.2% | 58.8% |
| Example 1 | | | | | | | | | | | | | | |
| Comparative | A-1 | 29.4% | B-1 | 4.9% | | | C-1 | 29.4% | E-2 | 34.3% | D-1 | 2.0% | 34.3% | 63.7% |
| Example 2 | | | | | | | | | | | | | | |

TABLE 2

| | | | | | | | | | | | Total of first |
|---|---|---|---|---|---|---|---|---|---|---|---|
| | | | | | | | | | | | monomer, |
| | Water | | | | | | | | | Total of second | second |
| | absorption | Refrac- | | | | Minimum | Maximum | | Proportion | monomer, | monomer, |
| | expansion | tive | Abbe | | Transmit- | thickness | thickness | | of first | polymer, and | polymer, and |
| | rate | index | number | | tance | d1 | d2 | | monomer | third monomer | third monomer |
| Unit | % | nd | vd | Birefringence | % | μm | μm | d2/d1 | % by mass | % by mass | % by mass |
| Example 1 | A | 1.575 | 35.6 | −0.00034 | 93.0% | 50 | 400 | 8.0 | 29.4% | 68.6% | 98.0% |
| Example 2 | A | 1.561 | 39.5 | −0.00026 | 92.0% | 30 | 380 | 12.7 | 19.6% | 78.4% | 98.0% |
| Example 3 | A | 1.549 | 44.3 | −0.00019 | 93.0% | 50 | 400 | 8.0 | 10.8% | 87.3% | 98.0% |
| Example 4 | A | 1.568 | 37.8 | −0.00029 | 91.0% | 50 | 400 | 8.0 | 23.5% | 74.5% | 98.0% |
| Example 5 | A | 1.563 | 38.9 | −0.00028 | 90.0% | 50 | 400 | 8.0 | 19.6% | 73.5% | 93.1% |
| Example 6 | A | 1.552 | 42.7 | −0.00023 | 89.0% | 50 | 400 | 8.0 | 10.8% | 77.5% | 88.2% |
| Example 7 | A | 1.571 | 35.8 | −0.00035 | 93.0% | 50 | 400 | 8.0 | 29.4% | 68.6% | 98.0% |
| Example 8 | A | 1.570 | 35.8 | −0.00036 | 93.0% | 50 | 400 | 8.0 | 29.4% | 68.6% | 98.0% |
| Example 9 | A | 1.571 | 35.8 | −0.00034 | 93.0% | 50 | 400 | 8.0 | 29.4% | 68.6% | 98.0% |
| Example 10 | A | 1.575 | 35.6 | −0.00034 | 93.0% | 50 | 400 | 8.0 | 29.4% | 68.6% | 98.0% |
| Comparative | A | 1.571 | 35.2 | −0.00043 | 90.0% | 50 | 400 | 8.0 | 19.6% | 39.2% | 58.8% |
| Example 1 | | | | | | | | | | | |
| Comparative | C | 1.575 | 35.6 | −0.00046 | 90.0% | 50 | 400 | 8.0 | 29.4% | 34.3% | 63.7% |
| Example 2 | | | | | | | | | | | |

The types of the first monomer, the second monomer, the polymer, the third monomer, another monomer, and the initiator in Table 1 are as described below.

### First Material

### First Monomer

A-1:9,9-Bis [4-(2-hydroxyethoxy)phenyl]fluorene diacrylate (difunctional, A-BPEF, available from Shin-Nakamura Chemical Co., Ltd.)

### Second Material

### Second Monomer

B-1: Dicyclopentenyloxyethyl methacrylate (monofunctional, FA-512M, available from Resonac Corp.)
B-2: Polymer of dicyclopentenyloxyethyl methacrylate (monofunctional, FA-512M, available from Resonac Corp.)
B-3: Dicyclopentanyl methacrylate (monofunctional, FA-513M, available from Resonac Corp.)
B-4: Polymer of dicyclopentanyl methacrylate (monofunctional, FA-513M, available from Resonac Corp.)
B-5: Isobornyl methacrylate (monofunctional, IB-X, available from Kyoeisha Chemical Co., Ltd.)
B-6:2-Ethyl-2-methacryloyloxyadamantane (monofunctional, Tokyo Chemical Industry Co., Ltd.)

### Third Monomer

C-1: Dimethylol tricyclodecane diacrylate (difunctional, A-DCP, available from Shin-Nakamura Chemical Co., Ltd.)

### Others

### Another Monomer

E-1: Ethoxylated bisphenol A diacrylate (difunctional, ABE-300, available from Shin-Nakamura Chemical Co., Ltd.)
E-2: Trimethylolpropane trimethacrylate (trifunctional, TMPT, available from Shin-Nakamura Chemical Co., Ltd.)

### Initiator

D-1: Diphenyl(2,4,6-trimethylbenzoyl) phosphine oxide (photoinitiator, Omnirad TPO H, available from IGM Resins)

### Example 2

Example 2 was different from Example 1 in the composition ratio of the resin composition. Specifically, 19.6 parts by mass of the first monomer A-1, 39.2 parts by mass of the second monomer B-1, 39.2 parts by mass of the third monomer C-1, and 2 parts by mass of the polymerization initiator D-1 were placed in a vessel and mixed uniformly to prepare a resin composition 2a of Example 2. Table 1 summarizes the characteristics of the resin composition 2a of Example 2. In addition, the shape of the mold 4 was different from that of Example 1. The optical element of Example 2 was manufactured in the same manner as in Example 1, except for the above.

The cured product of the optical element of Example 2 had a water absorption expansion rate of 0.13%, and no peeling was observed. Thus, the cured product was rated A. The cured product 2 of Example 2 had a refractive index nd of 1.561 at the d-line and an Abbe number νd of 39.5. The birefringence was −0.00026, which was sufficiently low. The internal transmittance at a thickness of 500 μm and a wavelength of 400 nm was 92.0%, which was good.

The cured product of the optical element of Example 2 had a shape with the minimum thickness at the center portion and the maximum thickness at the peripheral portion. The minimum thickness d1 was 30 μm, the maximum thickness d2 was 380 μm, and d2/d1 was 12.7. Table 2 summarizes the characteristics of the cured product 2 of Example 2.

### Example 3

Example 3 was different from Example 1 in the composition ratio of the resin composition. Specifically, 10.8 parts by mass of the first monomer A-1, 48.0 parts by mass of the second monomer B-1, 39.2 parts by mass of the third monomer C-1, and 2 parts by mass of the polymerization initiator D-1 were placed in a vessel and mixed uniformly to prepare a resin composition 2a of Example 3. The optical element of Example 3 was manufactured in the same manner as in Example 1, except for the above. Table 1 summarizes the characteristics of the resin composition 2a of Example 3.

The cured product of the optical element of Example 3 had a water absorption expansion rate of 0.14%, and no peeling was observed. Thus, the cured product was rated A. The cured product 2 of Example 3 had a refractive index nd of 1.549 at the d-line and an Abbe number νd of 44.3. The birefringence was −0.00019, which was sufficiently low. The internal transmittance at a thickness of 500 μm and a wavelength of 400 nm was 93.0%, which was good.

The cured product of the optical element of Example 3 had a shape with the minimum thickness at the center portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 3.

### Example 4

Example 4 was different from Example 1 in the composition of the resin composition. Dicyclopentenyloxyethyl methacrylate (B-1: monofunctional, FA-512M, available from Resonac Corp.) was provided as the second monomer, which is a monofunctional (meth)acrylate having an alicyclic skeleton. After 100 parts by mass of the dicyclopentenyloxyethyl methacrylate and 100 parts by mass of toluene were mixed, 1 part by mass of 2,2′-azobis(isobutyronitrile) (AIBN, available from Tokyo Chemical Industry Co., Ltd.) was added thereto. The mixture was heated at 60° C. for 6 hours while bubbling with nitrogen gas. Then the mixture was purified by reprecipitation in 1,000 parts by mass of methanol. Filtration and vacuum drying were performed to give a polymer of the second monomer. The weight-average molecular weight (Mw) of the polymer was 183,000 in terms of poly(methyl methacrylate). This polymer of dicyclopentenyloxyethyl methacrylate was designated as B-2. Specifically, the composition was 23.5 parts by mass of the first monomer A-1, 29.4 parts by mass of the second monomer B-1, 15.7 parts by mass of the polymer B-2 of the second monomer, 29.4 parts by mass of the third monomer C-1, and 2 parts by mass of the polymerization initiator D-1. These were placed in a vessel and mixed uniformly to prepare a resin composition 2a of Example 4. The optical element of Example 4 was manufactured in the same manner as in Example 1, except for the above. Table 1 summarizes the characteristics of the resin composition 2a of Example 4.

The cured product of the optical element of Example 4 had a water absorption expansion rate of 0.11%, and no peeling was observed. Thus, the cured product was rated A. The cured product 2 of Example 4 had a refractive index nd of 1.568 at the d-line and an Abbe number νd of 37.8. The birefringence was −0.00029, which was sufficiently low. The internal transmittance at a thickness of 500 μm and a wavelength of 400 nm was 91.0%, which was good.

The cured product of the optical element of Example 4 had a shape with the minimum thickness at the center portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 4.

### Example 5

Example 5 was different from Example 1 in the composition of the resin composition. As another monomer, ethoxylated bisphenol A diacrylate (E-1: ABE-300, difunctional, available from Shin-Nakamura Chemical Co., Ltd.), which is neither a fluorene skeleton nor an alicyclic skeleton, was used. Specifically, the composition was 19.6 parts by mass of the first monomer A-1, 44.1 parts by mass of the second monomer B-1, 29.4 parts by mass of the third monomer C-1, 4.9 parts by mass of E-1, and 2 parts by mass of the polymerization initiator D-1.

These were placed in a vessel and mixed uniformly to prepare a resin composition 2a of Example 5. The optical element of Example 5 was manufactured in the same manner as in Example 1, except for the above.

Table 1 summarizes the characteristics of the resin composition 2a of Example 5.

The cured product of the optical element of Example 5 had a water absorption expansion rate of 0.13%, and no peeling was observed. Thus, the cured product was rated A. The cured product 2 of Example 5 had a refractive index nd of 1.563 at the d-line and an Abbe number νd of 38.9. The birefringence was −0.00028, which was sufficiently low. The internal transmittance at a thickness of 500 μm and a wavelength of 400 nm was 90.0%, which was good.

The cured product of the optical element of Example 5 had a shape with the minimum thickness at the center portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 5.

### Example 6

Example 6 was different from Example 5 in the composition ratio of the resin composition. Specifically, the composition was 10.8 parts by mass of the first monomer A-1, 48 parts by mass of the second monomer B-1, 29.4 parts by mass of the third monomer C-1, 9.8 parts by mass of E-1, and 2 parts by mass of the polymerization initiator D-1. These were placed in a vessel and mixed uniformly to prepare a resin composition 2a of Example 6. The optical element of Example 6 was manufactured in the same manner as in Example 5, except for the above. Table 1 summarizes the characteristics of the resin composition 2a of Example 6.

The cured product of the optical element of Example 6 had a water absorption expansion rate of 0.14%, and no peeling was observed. Thus, the cured product was rated A. The cured product 2 of Example 6 had a refractive index nd of 1.552 at the d-line and an Abbe number νd of 42.7. The birefringence was −0.00023, which was sufficiently low. The internal transmittance at a thickness of 500 μm and a wavelength of 400 nm was 89.0%, which was good.

The cured product of the optical element of Example 6 had a shape with the minimum thickness at the center portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 6.

### Example 7

Example 7 was different from Example 1 in the composition of the resin composition. As the second monomer, dicyclopentanyl methacrylate (B-3: FA-513M, available from Resonac Corp.) was used. Specifically, the composition was 29.4 parts by mass of the first monomer A-1, 29.4 parts by mass of the second monomer B-3, 39.2 parts by mass of the third monomer C-1, and 2 parts by mass of the polymerization initiator D-1. These were placed in a vessel and mixed uniformly to prepare a resin composition 2a of Example 7. The optical element of Example 7 was manufactured in the same manner as in Example 1, except for the above. Table 1 summarizes the characteristics of the resin composition 2a of Example 7.

The cured product of the optical element of Example 7 had a water absorption expansion rate of 0.11%, and no peeling was observed. Thus, the cured product was rated A. The cured product 2 of Example 7 had a refractive index nd of 1.571 at the d-line and an Abbe number νd of 35.8. The birefringence was −0.00035, which was sufficiently low. The internal transmittance at a thickness of 500 μm and a wavelength of 400 nm was 93.0%, which was good.

The cured product of the optical element of Example 7 had a shape with the minimum thickness at the center portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 7.

### Example 8

Example 8 was different from Example 7 in the composition of the resin composition. Dicyclopentanyl methacrylate (B-3: monofunctional, FA-513M, available from Resonac Corp.) was used as the second monomer, which is a monofunctional (meth)acrylate having an alicyclic skeleton. After 100 parts by mass of the dicyclopentanyl methacrylate and 100 parts by mass of toluene were mixed, 1 part by mass of 2,2′-azobis(isobutyronitrile) (AIBN, available from Tokyo Chemical Industry Co., Ltd.) was added thereto. The mixture was heated at 60° C. for 6 hours while bubbling with nitrogen gas. Then the mixture was purified by reprecipitation in 1,000 parts by mass of methanol. Filtration and vacuum drying were performed to give a polymer of the second monomer. The weight-average molecular weight (Mw) of the polymer was 173,000 in terms of poly(methyl methacrylate). This polymer of dicyclopentanyl methacrylate was designated as B-4. Specifically, the composition was 29.4 parts by mass of the first monomer A-1, 29.4 parts by mass of the second monomer B-3, 9.8 parts by mass of the polymer B-4 of the second monomer, 29.4 parts by mass of the third monomer C-1, and 2 parts by mass of the polymerization initiator D-1. These were placed in a vessel and mixed uniformly to prepare a resin composition 2a of Example 8. The optical element of Example 8 was manufactured in the same manner as in Example 7, except for the above. Table 1 summarizes the characteristics of the resin composition 2a of Example 8.

The cured product of the optical element of Example 8 had a water absorption expansion rate of 0.09%, and no peeling was observed. Thus, the cured product was rated A. The cured product 2 of Example 8 had a refractive index nd of 1.570 at the d-line and an Abbe number νd of 35.8. The birefringence was −0.00036, which was sufficiently low. The internal transmittance at a thickness of 500 μm and a wavelength of 400 nm was 93.0%, which was good.

The cured product of the optical element of Example 8 had a shape with the minimum thickness at the center portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 8.

### Example 9

Example 9 was different from Example 1 in the composition of the resin composition. As the second monomer, isobornyl methacrylate (B-5: IB-X, available from Kyoeisha Chemical Co., Ltd.) was used. Specifically, the composition was 29.4 parts by mass of the first monomer A-1, 29.4 parts by mass of the second monomer B-5, 39.2 parts by mass of the third monomer C-1, and 2 parts by mass of the polymerization initiator D-1. These were placed in a vessel and mixed uniformly to prepare a resin composition 2a of Example 9. The optical element of Example 9 was manufactured in the same manner as in Example 1, except for the above. Table 1 summarizes the characteristics of the resin composition 2a of Example 9.

The cured product of the optical element of Example 9 had a water absorption expansion rate of 0.10%, and no peeling was observed. Thus, the cured product was rated A. The cured product 2 of Example 9 had a refractive index nd of 1.571 at the d-line and an Abbe number νd of 35.8. The birefringence was −0.00034, which was sufficiently low. The internal transmittance at a thickness of 500 μm and a wavelength of 400 nm was 93.0%, which was good.

The cured product of the optical element of Example 9 had a shape with the minimum thickness at the center portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 9.

### Example 10

Example 10 was different from Example 1 in the composition of the resin composition. As the second monomer, 2-ethyl-2-methacryloyloxyadamantane (B-6: available from Tokyo Chemical Industry Co., Ltd.) was used. Specifically, the composition was 29.4 parts by mass of the first monomer A-1, 29.4 parts by mass of the second monomer B-6, 39.2 parts by mass of the third monomer C-1, and 2 parts by mass of the polymerization initiator D-1. These were placed in a vessel and mixed uniformly to prepare a resin composition 2a of Example 10. The optical element of Example 10 was manufactured in the same manner as in Example 1, except for the above. Table 1 summarizes the characteristics of the resin composition 2a of Example 10.

The cured product of the optical element of Example 10 had a water absorption expansion rate of 0.10%, and no peeling was observed. Thus, the cured product was rated A. The cured product 2 of Example 10 had a refractive index nd of 1.575 at the d-line and an Abbe number νd of 35.6. The birefringence was −0.00034, which was sufficiently low. The internal transmittance at a thickness of 500 μm and a wavelength of 400 nm was 93.0%, which was good.

The cured product of the optical element of Example 10 had a shape with the minimum thickness at the center portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 10.

### Comparative Example 1

Comparative Example 1 was different from Example 5 in the composition ratio of the resin composition. Specifically, the composition was 19.6 parts by mass of the first monomer A-1, 9.8 parts by mass of the second monomer B-1, 29.4 parts by mass of the third monomer C-1, 39.2 parts by mass of E-1, and 2 parts by mass of the polymerization initiator D-1. These were placed in a vessel and mixed uniformly to prepare a resin composition 2a of Comparative Example 1. The optical element of Comparative Example 1 was manufactured in the same manner as in Example 5, except for the above. Table 1 summarizes the characteristics of the resin composition 2a of Comparative Example 1.

The cured product of the optical element of Comparative Example 1 had a water absorption expansion rate of 0.17%, and no peeling was observed. Thus, the cured product was rated A. The cured product 2 of Comparative Example 1 had a refractive index nd of 1.571 at the d-line and an Abbe number νd of 35.2. The birefringence was −0.00043. The internal transmittance at a thickness of 500 μm and a wavelength of 400 nm was 90.0%, which was good.

The cured product of the optical element of Comparative Example 1 had a shape with the minimum thickness at the center portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Comparative Example 1.

### Comparative Example 2

Comparative Example 2 was different from Example 1 in the composition of the resin composition. Trimethylolpropane trimethacrylate (E-2: TMPT, trifunctional, available from Shin-Nakamura Chemical Co., Ltd.), which has neither a fluorene skeleton nor an alicyclic skeleton, was used. Specifically, the composition was 29.4 parts by mass of the first monomer A-1, 4.9 parts by mass of the second monomer B-1, 29.4 parts by mass of the third monomer C-1, 34.3 parts by mass of E-2, and 2 parts by mass of the polymerization initiator D-1. These were placed in a vessel and mixed uniformly to prepare a resin composition 2a of Comparative Example 2. The optical element of Comparative Example 2 was manufactured in the same manner as in Example 1, except for the above. Table 1 summarizes the characteristics of the resin composition 2a of Comparative Example 2.

The cured product of the optical element of Comparative Example 2 had a water absorption expansion rate of 0.35%. Thus, the cured product was rated C.

The cured product 2 of Comparative Example 2 had a refractive index nd of 1.573 at the d-line and an Abbe number νd of 35.6. The birefringence was −0.00046. The internal transmittance at a thickness of 500 μm and a wavelength of 400 nm was 90.0%, which was good.

The cured product of the optical element of Comparative Example 2 had a shape with the minimum thickness at the center portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Comparative Example 2.

Table 2 indicates that in each of Examples 1 to 10, in which the total amount of the first monomer, the second monomer, the polymer of the second monomer, and the third monomer contained was 70% or more by mass and 99.5% or less by mass, the cured product had a water absorption expansion rate of less than 0.30% and a low birefringence of less than 0.0004.

From the above, it was found that, according to the present disclosure, it is possible to provide a resin composition that has low birefringence and that is less prone to change in optical performance even in a high-humidity environment.

According to the above embodiment, it is possible to provide the resin composition in which even in the cured product after curing, the optical performance is less prone to change even in a high-humidity environment, and the birefringence is low.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-001529 filed Jan. 9, 2024, which is hereby incorporated by reference herein in its entirety.

What is claimed is:

1. A resin composition, comprising:
a first monomer containing a polymerizable functional group of a difunctional (meth)acrylate having a fluorene skeleton represented by formula (1); and
at least one of a second monomer containing a polymerizable functional group of a monofunctional (meth)acrylate having an alicyclic skeleton represented by any of formulae (2) to (5), a polymer of the second monomer, and a third monomer containing a polymerizable functional group of a difunctional (meth)acrylate having an alicyclic skeleton represented by any of formulae (2) to (5),
wherein a total amount of the first monomer, the second monomer, the polymer of the second monomer, and the third monomer contained is 70% or more by mass and 99.5% or less by mass, 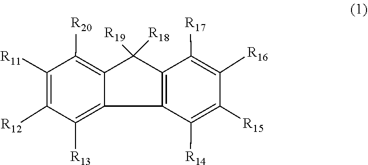
where in formula (1), at least two of R₁₁ to R₂₀ each contain a polymerizable functional group of a (meth)acrylate, and remaining groups are each a hydrogen atom or an organic group, 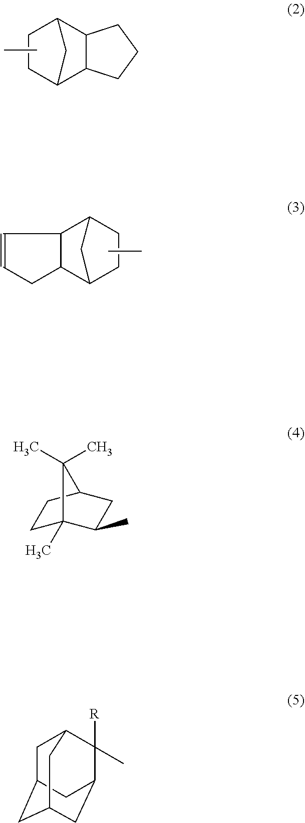
where in formula (5), R is a hydrogen atom, an alkyl group, or a substituted or unsubstituted alkylene group.

2. The resin composition according to claim 1, wherein the first monomer is represented by formula (6): 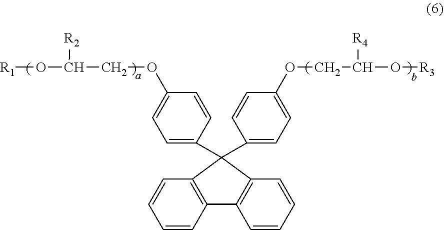
where in formula (6), R₁ and R₃ are each selected from 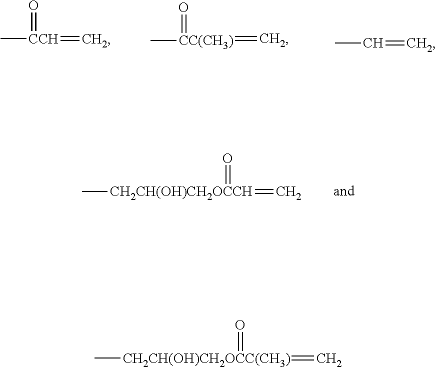
and R₂ and R₄ are each a hydrogen atom, CH₂, or an alkyl group.

3. The resin composition according to claim 1, wherein an amount of the first monomer contained is 10% or more by mass and 30% or less by mass.

4. The resin composition according to claim 1, wherein a total amount of the second monomer, the polymer of the second monomer, and the third monomer contained is 40% or more by mass and 85.9% or less by mass.

5. The resin composition according to claim 1, wherein the resin composition contains the second monomer and the third monomer.

6. An optical element, comprising:
a transparent base material; and
a cured product of the resin composition according to claim 1 disposed on the transparent base material.

7. The optical element according to claim 6, wherein the cured product has a refractive index nd of 1.54 or more and 1.58 or less and an Abbe number νd of 30 or more and less than 45.

8. The optical element according to claim 6, wherein a difference between a refractive index of the cured product in a plane facing the transparent base material and a refractive index of the cured material in a thickness direction is within 0.0004.

9. The optical element according to claim 6, wherein the cured product with a converted thickness of 500 μm has an internal transmittance of 70% or more at a wavelength of 400 nm.

10. The optical element according to claim 6, wherein the transparent base material has a first surface with a concave spherical shape, and
the cured product is disposed over the first surface.

11. The optical element according to claim 6, wherein a ratio of a maximum thickness d2 to a minimum thickness d1 of the cured product is more than 1 and 30 or less.

12. The optical element according to claim 11, wherein the minimum thickness d1 is 300 μm or less, and the maximum thickness d2 is 10 μm or more and 1,000 μm or less.

13. The optical element according to claim 6, wherein the cured product has a water absorption expansion rate of less than 0.30%.

14. An optical apparatus, comprising:
a housing; and
an optical system including one or more lenses disposed in the housing,
wherein at least one of the lenses is the optical element according to claim 6.

15. An image pickup apparatus, comprising:
a housing;
an optical system including one or more lenses disposed in the housing; and
an image pickup element configured to receive light passing through the optical system,
wherein at least one of the lenses is the optical element according to claim 6.

16. A method for manufacturing an optical element, comprising:
a preparation step of preparing a transparent base material and the resin composition according to claim 1;
a disposition step of disposing the resin composition on the transparent base material with a mold; and
a curing step of polymerizing or copolymerizing the resin composition to provide a cured product.

17. The method for manufacturing an optical element according to claim 16, wherein the curing step includes a light irradiation step of polymerizing or copolymerizing the resin composition by light irradiation.
